(19) United States
(12) Patent Application Publication
(10) Pub. No.: US 2008/0087864 A1
(43) Pub. Date: Apr. 17, 2008

(54) Stabilizer Composition for Halogenated Polymers

(76) Inventors: Frank Mulder, Odelzhausen/Sittenbach (DE); Hans-Jurgen Sander, Lorsch (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/596,587

(22) PCT Filed: Dec. 13, 2004
(86) PCT No.: PCT/EP04/14172

§ 371 Date: May 7, 2007

(30) Foreign Application Priority Data
Dec. 17, 2003 (DE) 103 59 318.7

(51) Int. Cl. C09K 15/32

(52) U.S. Cl. 252/400.51; 524/399

(57) ABSTRACT

The present invention relates to stabilizer compositions for halogenated polymers, containing perchlorates and lead compounds, to polymer compositions containing said stabilizer compositions as well as to moulded articles that can be produced by using the described stabilizer compositions or polymer compositions.

The present invention relates to stabilizer compositions for halogenated polymers, to polymer compositions comprising said stabilizer compositions, as well as to moulded articles that are produced by using the described stabilizer compositions or polymer compositions. The stabilizer compositions comprise perchlorates and lead salts.

It is known that halogen-containing plastics have a tendency to undergo undesirable decomposition and degradation reactions under thermal stress during processing or during long-term use. During the decomposition of halogenated polymers, especially in the case of PVC, hydrochloric acid is generated, which is eliminated from the polymer strand, resulting in a discoloured, unsaturated plastic having colour-imparting polyene sequences.

A particular problem in that case is that halogen-containing polymers exhibit the Theological conditions necessary for processing only at a relatively high temperature. At such temperatures, however, in the case of unstabilized polymers the polymer already begins to undergo significant decomposition, which results both in the undesirable colour change described above and in a change in the material properties. Furthermore, the hydrochloric acid freed from non-stabilized, halogen-containing polymers at such a processing temperature can lead to significant corrosion of the processing apparatus. That process plays a particular role when during the processing of such halogenated polymers to form moulded articles, for example by extrusion, production is interrupted and the polymer mass remains in the extruder for a prolonged period.

The mentioned problems are usually solved by the application of stabilizers, which are added to the halogen-containing polymer before or during the processing. Such known stabilizers are for example the lead stabilizers, barium stabilizers, cadmium stabilizers, organotin stabilizers as well as barium-cadmium, barium-zinc or calcium-zinc stabilizers.

Therefore, since a long time, stabilizers are added during the processing of halogen-containing polymers, which shall inhibit the degradation of the halogen-containing polymer during the processing. Indeed, in particular in recent years, many promising tries were made to eliminate heavy metals in stabilizer compositions. However, so far, in many areas demands on stabilizer compositions persist, which have properties such as they are often only achieved by the application of heavy metals.

The stabilizer compositions known in the prior art often concern mixtures that comprise lead salts. While in particular compositions that comprise lead salts are known for their good stabilizing effects, however, the compositions known from the prior art fail especially at sensitive test procedures, such as they are conduced in different countries or rather such as they are permission requirements for stabilizer compositions.

EP 0 313 113 A1 describes a 3-basic lead dimethylolpropionate as lead stabilizer of a new generation as well as a stabilizer composition for halogen-containing vinyl polymers comprising said compounds. In principle, indeed good stabilizing results can be achieved by the stabilizers described therein. However, in relation to the achieved stabilizing result, the application quantity of the stabilizers is high.

Especially demanding tests for the determination of the stabilizing properties, for example the test according to DIN 53381 part 1 method B (DHC test), in particular, however, the test according to UEAtc, such as it is particularly used in France for the quality inspection of PVC, which shall be applied in the production of window frames, make great demands on the properties of stabilizers. A stabilizer composition, which shows by all means suitable stabilizing properties within the scope of conventional test, however often fails in the quality demands of the customer and the methods of inspection, such as they are forced by the last-mentioned tests, in particular by the UEAtc test.

Therefore, there was a need for a stabilizer combination for halogenated polymers that also allows especially high quality demands. There was a special need for a stabilizer combination that provides a good initial colour at the production of moulded articles from halogen-containing polymers and that maintains also during temporary interrupts of production and a higher thermal stress of the material associated therewith. Furthermore, there was a need for stabilizer combinations that minimizes the required amount of heavy metals and that nevertheless shows excellent stabilizing properties. In particular, there was a need for a stabilizer combination that shows excellent stabilizing results also under the conditions of the UEAtc tests.

The object of the present invention is therefore to provide a stabilizer combination for halogen-containing polymers, which satisfies the above mentioned needs. Furthermore, the object of the present invention is to provide a process for stabilizing halogen-containing polymers. Moreover, the object of the present invention is to provide a polymer composition that also shows an excellent stability under the conditions of the UEAtc tests.

These objects of the invention are provided by a stabilizer composition, by a process for stabilizing halogen-containing polymers and by a polymer composition, as described hereinbelow.

Therefore, the subject matter of the present invention is a stabilizer composition for halogen-containing polymers, at least comprising a lead compound or a mixture of two or more lead compounds and a salt of a halogen-containing oxy acid or a mixture of two or more salts of one or more halogen-containing oxy acids, whereas the stabilizer composition comprises at least one salt of a halogen-containing oxy acid in supported form.

A “stabilizer composition” is to be understood in the context of the present invention as being a composition that can be used for the stabilization of halogen-containing polymers. For achieving that stabilization effect, a stabilizer composition according to the invention is generally mixed with a halogen-containing polymer to be stabilized and then processed. However, it is equally possible for a stabilizer composition according to the invention to be admixed to the halogen-containing polymer to be stabilized during processing.

A stabilizer composition according to the invention has at least two constituents. As a first constituent a composition according to the invention comprises at least one lead compound.

Within the context of the present invention, in principle all organic or inorganic substances, which have a content of lead in ionic or coordinated or metallic form, are suitable as lead compounds. Especially suitable are for example basic lead salts of inorganic acids such as tribasic lead sulfate, tetrabasic lead sulfate, dibasic lead phosphite or dibasic lead phosphite-sulphite or lead carbonate (white lead), lead salts of linear or branched, saturated or unsaturated, aliphatic or cycloaliphatic or aromatic organic mono- or poly-carboxylic acids such as acetic acid, propionic acid, butyric acid, valeric acid, hexanoic acid, oenanthic acid, octanoic acid, neodecanoic acid, 2-ethylhexanoic acid, pelargonic acid, decanoic acid, undecanoic acid, dodecanoic acid, tridecanoic acid, myristic acid, palmitic acid, lauric acid, isostearic acid, stearic acid, 12-hydroxystearic acid, 9,10-dihydroxystearic acid, oleic acid, 3,6-dioxaheptanoic acid, 3,6,9-trioxadecanoic acid, behenic acid, benzoic acid, p-tert-butylbenzoic acid, dimethylhydroxybenzoic acid, 3,5-di-tert-butyl-4-hydroxybenzoic acid, toluic acid, dimethylbenzoic acid, ethylbenzoic acid, n-propylbenzoic acid, salicylic acid, p-tert-octylsalicylic acid, sorbic acid, divalent carboxylic acids or monoesters thereof, such as oxalic acid, malonic acid, maleic acid, fumaric acid, tartaric acid, cinnamic acid, mandelic acid, malic acid, glycolic acid, oxalic acid, salicylic acid, polyglycoldicarboxylic acids having a degree of polymerisation of from about 10 to about 12, phthalic acid, isophthalic acid, terephthalic acid or hydroxyphthalic acid, tri- or tetra-valent carboxylic acids or mono-, di- or tri-esters thereof, such as in hemimellitic acid, trimellitic acid, pyromellitic acid or citric acid, or dimerised or trimerised linoleic acid, acrylic acid, methacrylic acid as well as the mono- or poly-carboxylic acids mentioned hereinbelow. Also suitable are cycloaliphatic carboxylic acids, such as cyclohexanecarboxylic acid, tetrahydrophthalic acid, 4-methyltetrahydrophthalic acid, hexahydrophthalic acid, endomethylenetetrahydrophthalic acid or 4-methylhexahydrophthalic acid. Especially suitable are neutral or basic lead stearate, white lead, 3- or 4-basic lead sulfate, 2-basic lead phosphite, 2-basic lead phthalate or 4-basic lead fumarate.

Lead compounds, such as they are obtained by the reaction of lead oxide with organic hydroxy-carboxylic acids such as dimethylolpropionic acid, are also suitable as lead compounds. Such compounds and the preparation thereof are, for example, described in EP 0 313 113, the disclosure of this document concerning lead compounds, such as they are obtained by the reaction of lead oxide with organic hydroxy-carboxylic acids, being regarded as part of the disclosure of the present text.

A stabilizer composition according to the invention comprises, for example, only one lead compound. However, according to the invention, it is also possible and provided that a stabilizer composition according to the invention comprises a mixture of two or more lead compounds. However, for example, it is possible that one or more lead compounds are of the inorganic type and one or more lead compounds are of the organic type. However, it is also possible that a mixture of inorganic lead compounds or a mixture of organic lead compounds is solely used. Within the scope of a preferred embodiment of the present invention, a stabilizer composition according to the invention comprises a mixture of two or more, for example a mixture of 2, 3, 4 or 5 different lead compounds. Within the scope of a further embodiment of the present invention, a stabilizer composition according to the invention comprises a mixture of one, two or three inorganic lead compounds and one, two or three organic lead compounds. Within the scope of a further embodiment of the present invention, a stabilizer composition according to the invention comprises a mixture of lead phosphite or sulfate or mixtures thereof and at least one organic lead compound, in particularly a lead salt of an organic carboxylic acid.

The content of a stabilizer composition according to the invention of lead compounds is all in all at least about 5% by weight, always based on the total stabilizer composition. Within the scope of a preferred embodiment of the present invention, the content of a stabilizer composition according to the invention of one or more lead compounds is about 10 to about 95% by weight. Thereby, for example, a composition according to the invention can also have a content of lead compounds within these limits, for example about 20 to about 90% by weight or about 30 to about 75% by weight or substantially any values that lie in-between, provided that the corresponding lead content effects an adequate stabilization.

If a stabilizer composition according to the invention comprises inorganic and organic lead compounds, the weight proportion of inorganic to organic lead compounds is preferably about 100:1 to about 1:100. However, in some cases, it has advantageously turned out if in these cases the portion of inorganic lead compounds exceeds the portion of organic lead compounds. Thus, within the scope of a further embodiment of the present invention, for example inorganic and organic lead compounds are applied in a ratio of about 1:1 to about 30:1, for example in a ratio of about 2:1 to about 10:1.

In addition to a lead compound or a mixture of two or more lead compounds, such as they are for example described above, a stabilizer composition according to the invention also comprises at least one salt of a halogen-containing oxy acid or a mixture of two or more salts of a halogen-containing oxy acid or a mixture of two or more salts of different halogen-containing oxy acids.

For example, salts of halogen-containing oxy acids, in particular perchlorates, are suitable as at least one further compound. Examples of suitable perchlorates are those of the general formula M(ClO₄)ₙ, wherein M is Li, Na, K, Mg, Ca, Sr, Zn, Al, La or Ce. The index n, according to the valency of M, is the number 1, 2 or 3. The mentioned perchlorate salts can be complexed with alcohols (polyols, cyclodextrins) or ether alcohols or rather ester alcohols. Ester alcohols also include the polyol partial esters. As polyvalent alcohols or polyols also their dimers, trimers, oligomers and polymers are considered, such as di-, tri-, tetra- and polyglycols, as well as di-, tri- and tetra-pentaerythritol or polyvinyl alcohol in different degrees of polymerisation and saponification. As polyol partial esters preference is given to glycerol monoethers and glycerol monothioethers. Sugar alcohols are also suitable.

Thereby, the perchlorate salts can be used in various common delivery forms, for example in the form of a salt or an aqueous solution supported on a suitable carrier material, such as PVC, calcium silicate, zeolites or hydrotalcites, or bonded by chemical reaction into a hydrotalcite. A combination of sodium perchlorate and calcium silicate that is suitable as a constituent of the stabilizer composition according to the invention can be obtained, for example, by combining an aqueous solution of sodium perchlorate (content of sodium perchlorate about 60% or more) with calcium silicate, for example with a synthetic, amorphous calcium silicate. Suitable particle sizes for the calcium silicate suitable for use are, for example, from about 0.1 to about 50, for example about 1 to about 20 μm. Suitable perchlorate-containing delivery forms are described, for example, in U.S. Pat. No. 5,034,443, reference being expressly made to the perchlorate-containing delivery forms disclosed therein and that disclosure being regarded as part of the disclosure of the present text.

Further suitable delivery forms are mentioned, for example, in EP-A 394,547, EP-A 457,471 and WO 94/24200, reference being expressly made to the suitable delivery forms disclosed therein and that disclosure being regarded as part of the disclosure of the present text.

A stabilizer composition according to the invention can for example comprise only one salt of a halogen-containing oxy acid. However, within the scope of the present invention, it is also possible and provided that a stabilizer composition according to the invention comprises a mixture of two or more salts of halogen-containing oxy acids. Within the scope of a preferred embodiment of the present invention, a stabilizer composition according to the invention comprises sodium perchlorate.

In the context of a further embodiment of the present invention, the salts of the halogen-containing oxy acids are present in a stabilizer composition according to the invention in especially finely distributed form. Thereby, within the scope of a preferred embodiment of the present invention, less than 10% by weight of the salts of the halogen-containing oxy acid or of the mixture of two or more of such salts have crystallites of a size of greater than 3 μm. From this, it follows that at least 90% by weight of the salts have crystallites of a size of smaller than 3 μm.

Within the scope of a further embodiment of the present invention, a stabilizer composition according to the invention comprises a salt of a halogen-containing oxy acid or a mixture of two or more halogen-containing oxy acids, whereas less than about 10% by weight of the salt or of the salt mixture is present in form of crystallites of a size greater than 1 μm, preferably of a size greater than 500 nm. Within the scope of a further preferred embodiment of the present invention, a stabilizer composition according to the invention is substantially free of crystallites of salts of halogen-containing oxy acids having a crystallite size greater than about 250 nm. In the context of especially preferred embodiments of the present invention, a stabilizer composition according to the invention comprises crystallites of salts of halogen-containing oxy acids having a crystallite size greater than about 100 nm or greater than about 50 nm or greater than about 20 nm or greater than about 10 or about 5 nm.

The crystallite size of salts of halogen-containing oxy acids, such as they are mentioned in the context of the present text, can be determined in principle by any methods of determining particle sizes. Suitable in principle are, for example, screening methods, sedimentation methods or methods based on the diffraction or refraction of electromagnetic waves, especially of light. Also suitable are electron-microscopic methods, such as scanning electron microscopy or transmission electron microscopy.

Within the scope of a further preferred embodiment of the present invention, a stabilizer composition according to the invention is free of crystallites, such as are detectable by X-ray diffractometric methods. A stabilizer composition according to the invention therefore preferably comprises crystallites having sizes beyond the detection limit of such methods. The size of such crystallites is preferably below about 10 nanometres, preferably below about 5 nanometres.

Also suitable as constituent of the stabilizer composition according to the invention are salts of halogen-containing oxy acids which are supported on a carrier material. Especially suitable are thereby compositions in which calcium/aluminium hydroxyphosphites of the general formula (I) CaₓAl₂(OH)₂₍ₓ₊₂₎HPO₃.mH₂O (I), wherein x is a number from 2 to 8 and m is a number from 0 to 12, is used as carrier material for the salt of a halogen-containing oxy acid.

The term “carrier material” is to be understood as being a material that can have, at least on the surface, a compound other than the carrier material which is present in finely distributed form on the carrier material. The expression “on the carrier material” is thereby to be interpreted as meaning that at least a major portion of the compound present on the carrier material adheres firmly to the carrier material as a result of interactions between the carrier material and the compound. The interactions can essentially be any interactions; for example ionic, electrostatic, covalent or Van der Waals forces or two or more such interactions simultaneously may provide adhesion to the carrier material.

In the formula I above, x is preferably a number from 3 to 6 and m is preferably a number from 2 to 4. Experiments using X-ray diffraction have shown that the compounds used according to the invention as carrier materials do not belong to the hydrotalcite type in respect of their crystal structure.

For the preparation of the calcium/aluminium hydroxyphosphites used according to the invention as carrier materials, for example mixtures of calcium hydroxide and/or oxide, aluminium hydroxide and sodium hydroxide or of calcium hydroxide and/or oxide and sodium aluminate are reacted with phosphorous acid in amounts suitable for the preparation of the desired compounds in an aqueous medium and the reaction product is separated and obtained in a manner known per se.

The reaction product directly obtained from the reaction described above can be separated from the aqueous reaction medium by known methods, preferably by filtration. The working-up of the separated reaction product is likewise effected in a manner known per se, for example by washing the filter cake with water and drying the washed residue at temperatures of, for example, 60-130° C., preferably at 90-120° C.

For the reaction there can be used either a finely particulate, active aluminium hydroxide in combination with sodium hydroxide or a sodium aluminate. Calcium can be used in the form of finely particulate calcium oxide or hydroxide or mixtures thereof. The phosphorous acid can be used in various concentrations.

The reaction temperatures are preferably between about 50 and 100° C., preferably between about 60 and 85° C. Catalysts or accelerators are not required. In the case of the compounds according to the invention, some or all of the water of crystallisation can be removed by thermal treatment. When used as stabilizers, the dried calcium/aluminium hydroxyphosphites used according to the invention do not split off water at the processing temperatures of 160-200° C. customary, for example, for hard PVC, so that no troublesome bubble formation occurs in the moulded articles.

In addition to the above described inorganic salts of halogen-containing oxy acids, a stabilizer composition according to the invention can also comprise an organic onium salt of halogen-containing oxy acids.

In the context of the present text, the term “onium salt” denotes a compound that is an ammonium, sulfonium or phosphonium salt. An “onium salt” is an organic onium salt. That means that the ammonium, sulfonium or phosphonium group of the onium salt carries at least one organic radical. An onium salt according to the present invention may thereby carry 1, 2, 3 or 4 organic radicals according to the nature of the onium group. The organic radicals can thereby be bonded to the onium radical, for example, by way of a C—X linkage, where X is S, N or P. It is equally possible, however, for the organic radicals to be bonded to the onium radical by way of a further hetero atom, for example an O atom.

A salt of a halogen-containing oxy acid, for example an onium perchlorate, suitable for use in the context of the present invention has at least one positively charged N, P or S atom or two or more such positively charged N, P or S atoms or mixtures of two or more of the mentioned, positively charged, atom types.

In the context of the present invention, as onium perchlorates there are for example used compounds that carry at least one organic radical and at most the maximum possible number of organic radicals on the N, S or P atom. When an onium perchlorate suitable for use according to the invention carries a smaller number of organic radicals than is necessary for the formation of a positively charged onium ion, the positive charge is generated in a customary manner known to the person skilled in the art by protonation by means of a suitable acid, so that the onium perchlorate in question then carries at least one proton in addition to an organic radical.

It is therefore possible according to the invention to use as onium perchlorates compounds having a positive charge as a result of protonation reactions. It is, however, equally possible in the context of the stabilizer combinations according to the invention to use onium perchlorates having a positive charge as a result of a peralkylation reaction. Examples of such compounds are tetraalkylammonium, trialkylsulfonium and tetraalkylphosphonium perchlorates. It is, however, also provided in the context of the present invention for a peralkylated onium perchlorate suitable for use according to the invention to have an aryl, alkaryl, cycloalkyl, alkenyl, alkynyl or cycloalkenyl radical. It is likewise possible and provided according to the invention for an onium salt suitable for use in the context of a stabilizer composition according to the invention to have two or optionally more different types of substituent, for example an alkyl radical and a cycloalkyl radical or an alkyl radical and an aryl radical.

It is likewise possible and provided in the context of the present invention for an onium salt suitable for use in a stabilizer composition according to the invention to have substituents that are themselves substituted by one or more functional groups. The term “functional groups” thereby denotes groups that improve the effect of the stabilizer composition or at least do not impair that effect or impair it only to a negligible extent. Such functional groups can for example be NH groups, NH₂ groups, OH groups, SH groups, ester groups, ether groups, thioether groups, isocyanurate groups or keto groups or mixtures of two or more thereof.

Within the scope of the present invention, in principle any compounds, which result in a phosphonium perchlorate by appropriate reaction of suitable reactants, are applicable as phosphonium perchlorates. Phosphonium perchlorates suitable for use according to the invention can be obtained, for example, by appropriate reaction of tetraalkyl-, tetracycloalkyl- or tetraaryl-phosphorus halides. Suitable phosphonium perchlorates are therefore derived, for example, from tetraalkylphosphorus salts, such as tetra-n-ethylphosphonium bromide, tetra-n-propylphosphonium bromide, tetra-n-butylphosphonium bromide, tetra-n-isobutylphosphonium bromide, tetra-n-pentylphosphonium bromide, tetra-n-hexylphosphonium bromide and the like tetraalkylphosphorus salts. Also suitable in principle for use in the context of the stabilizer compositions according to the invention are phosphonium perchlorates derived, for example, from tetracycloalkylphosphorus salts or tetraarylphosphorus salts. Suitable phosphonium perchlorates are therefore based, for example, on tetracycloalkyl- or tetraaryl-phosphorus salts such as tetracyclohexylphosphonium bromide or tetraphenylphosphonium bromide and the like tetracycloalkyl- or tetraaryl-phosphorus salts. The compounds mentioned above can be unsubstituted in the context of the present invention, but they may also have one or more of the above-mentioned substituents provided that, in the context of the stabilizer composition, those substituents have no disadvantageous effect and have no adverse effect on the intended use of the stabilizer composition.

Also suitable for use in the context of the present invention are organic phosphonium perchlorates that carry at a phosphorus atom different types of organic substituents which may optionally be differently substituted.

Within the scope of a preferred embodiment of the present invention, tetra-n-butylphosphonium perchlorate or triphenylbenzylphosphonium perchlorate is used as phosphonium perchlorate.

In the context of the present invention, in principle any compounds, which result in a sulfonium perchlorate by appropriate reaction of suitable reactants, are applicable as sulfonium perchlorates. Thereby, sulfonium perchlorates suitable for use according to the invention can be obtained, for example, by appropriate reaction of sulfides such as alkyl monosulfides, alkyl disulfides, dialkylsulfides or polyalkylsulfides. Suitable sulfonium perchlorates are therefore derived, for example, from dialkyl sulfides such as ethyl benzyl sulfide, allyl benzyl sulfide or alkyl disulfides such as hexane disulfide, heptane disulfide, octane disulfide and the like alkyl disulfides. Also suitable in principle for use in the context of the stabilizer compositions according to the invention are sulfonium perchlorates derived, for example, from tricycloalkyl-sulfonium salts or triarylsulfonium salts. Suitable sulfonium perchlorates are therefore based, for example, on tricycloalkyl- or triaryl-sulfonium salts such as tricyclohexylsulfonium bromide or triphenylsulfonium bromide and the like tricycloalkyl- or triaryl-sulfonium salts. Also suitable are trialkyl-, triaryl- or tricycloalkyl-sulfoxonium salts such as trimethylsulfoxonium perchlorate. The compounds mentioned above can be unsubstituted in the context of the present invention, but they may also have one or more of the above-mentioned substituents provided that, in the context of the stabilizer composition, those substituents have no disadvantageous effect and have no adverse effect on the intended use of the stabilizer composition.

Also suitable for use in the context of the present invention are organic sulfonium perchlorates that carry at a sulfur atom different types of organic substituents which may optionally be differently substituted.

Within the scope of a preferred embodiment of the present invention, trimethylsulfoxonium perchlorate is used as sulfonium perchlorate.

In the context of the present invention, in principle any compounds, which result in an ammonium perchlorate by appropriate reaction of suitable reactants, are applicable as ammonium perchlorates. Thereby, ammonium perchlorates suitable for use in accordance with the invention can be obtained, for example, by appropriate reaction of amines or amides such as alkyl monoamines, alkylenediamines, alkyl polyamines, or secondary or tertiary amines or dialkyl amines. Suitable ammonium perchlorates are therefore derived, for example, from primary mono- or poly-amino compounds having from 2 to about 40 carbon atoms, for example from 6 to about 20 carbon atoms. Examples thereof are ethylamine, n-propylamine, isopropylamine, n-butylamine, sec-butylamine, tert-butylamine, substituted amines having from 2 to about 20 carbon atoms, such as 2-(N,N-dimethylamino)-1-aminoethane. Suitable diamines have, for example, two primary, two secondary, two tertiary or one primary and one secondary or one primary and one tertiary or one secondary and one tertiary amino group(s). Examples thereof are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane or tertiary amines such as triethylamine, tributylamine, dimethylbenzylamine, N-ethyl-, N-methyl-, N-cyclohexyl-morpholine, dimethylcyclohexylamine, dimorpholinodiethyl ether, 1,4-diazabicyclo[2.2.2]octane, 1-azabicyclo[3.3.0]octane, N,N,N′,N′-tetramethylethylenediamine, N,N,N′,N′-tetramethylbutanediamine, N,N,N′,N′-tetramethylhexane-1,6-diamine, pentamethyldiethylenetriamine, tetramethyldiaminoethyl ether, bis(dimethylaminopropyl)urea, N,N′-dimethylpiperazine, 1,2-dimethylimidazole or di(4-N,N-dimethylaminocyclohexyl)methane.

Also suitable are aliphatic amino alcohols having from 2 to about 40, preferably from 6 to about 20 carbon atoms, for example triethanolamine, tripropanolamine, tributanolamine, tripentanolamine, 1-amino-3,3-dimethyl-pentane-5-ol, 2-aminohexane-2′,2″-diethanolamine, 1-amino-2,5-dimethylcyclohexane-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentane-methanol, 2-amino-2-ethyl-1,3-propanediol, 2-(dimethylaminoethoxy)-ethanol, aromatic-aliphatic or aromatic-cycloaliphatic amino alcohols having from 6 to about 20 carbon atoms, whereas heterocyclic or isocyclic ring systems such as naphthalene derivatives or especially benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol and also mixtures of two or more of such compounds are used as aromatic structures.

Within the scope of a further embodiment of the present invention, perchlorates of heterocyclic compounds having a cyclic ring system containing amino groups are used as ammonium perchlorates.

For example, there are used the perchlorates of heterocyclic amino alcohols that have at least 2, preferably at least 3, amino groups in the ring. As central ring component of the ammonium perchlorates suitable for use according to the invention there are especially suitable the trimerisation products of isocyanates.

In the context of the present invention, a stabilizer composition according to the invention may for example comprise only one of the above-mentioned onium perchlorates. In the context of the present invention it is equally possible and also provided for a stabilizer composition according to the invention to comprise a mixture of two or more of the above-mentioned onium perchlorates. It may be a mixture of two or more different types of onium perchlorates, that is to say, for example, a mixture of ammonium perchlorates and sulfonium perchlorates or ammonium perchlorates and phosphonium perchlorates or sulfonium perchlorates and phosphonium perchlorates or ammonium perchlorates and sulfonium perchlorates and phosphonium perchlorates. It is equally possible in the context of the invention that a stabilizer composition according to the invention comprises a mixture of two or more onium perchlorates of one type, that is to say a mixture of two or more ammonium perchlorates and a mixture of two or more sulfonium perchlorates and a mixture of two or more phosphonium perchlorates.

Within the scope of the present invention, the content of a composition according to the invention of salts of a halogen-containing oxy acid or of a mixture of two or more salts of a halogen-containing oxy acid or of a mixture of two or more salts of different halogen-containing oxy acids is about 0.01 to about 50% by weight, in each case based on the total stabilizer composition and the salt of a halogen-containing oxy acid or a mixture of two or more thereof. In the context of the present invention, contents of about 0.1 to about 40 or about 0.2 to about 30% by weight, for example about 0.5 to about 20% by weight, based on the total stabilizer composition and the salt of a halogen-containing oxy acid or a mixture of two or more thereof, are especially suitable.

Thereby, it has turned out being additionally suitable, if the ratio of lead compounds to salts of a halogen-containing oxy acid in a stabilizer composition according to the invention is all in all about 5000:1 to about 1:1. Especially suitable are for example ratios within a range of about 1000:1 to about 3:1 or about 500:1 to about 5:1.

In addition to a lead compound or a mixture of two or more lead compounds and a salt of a halogen-containing oxy acid or a mixture of two or more such salts, a stabilizer composition according to the invention can also comprise one or more additives.

For example, inorganic bases are suitable as additives. The inorganic bases are solid compounds such as the hydroxides of elements of the first and second main group of the periodic system as well as the hydroxides of elements of the first auxiliary group of the periodic system. Magnesium hydroxide, calcium hydroxide, barium hydroxide or strontium hydroxide are especially suitable.

If such compounds are present in a stabilizer composition according to the invention, the content of a composition according to the invention of corresponding compounds is, within the scope of the present invention, about 0.1 to about 20% by weight.

Within the scope of a preferred embodiment of the present invention, a stabilizer composition according to the invention comprises calcium hydroxide or magnesium hydroxide, in particular calcium hydroxide, as inorganic base.

Also suitable as additives are epoxy compounds. Examples for such epoxy compounds are epoxidised soybean oil, epoxidised olive oil, epoxidised linseed oil, epoxidised castor oil, epoxidised groundnut oil, epoxidised maize oil, epoxidised cottonseed oil as well as glycidyl compounds.

Glycidyl compounds contain a glycidyl group that is bonded directly to a carbon, oxygen, nitrogen or sulfur atom. Glycidyl or methylglycidyl esters are obtainable by reaction of a compound having at least one carboxyl group in the molecule and epichlorohydrin or glycerol dichlorohydrin or methyl-epichlorohydrin. The reaction is advantageously carried out in the presence of bases.

Especially suitable epoxy compounds are described, for example, on pages 3 to 5 of EP-A 1 046 668, reference being expressly made to the disclosure contained therein, which is to be regarded as part of the disclosure of the present text.

Also suitable as additives in the context of the present invention are 1,3-dicarbonyl compounds, especially the β-diketones and β-keto esters. Suitable in the context of the present invention are dicarbonyl compounds of the general formula R′C(O)CHR″—C(O)R′″, such as described, for example, on page 5 of EP 1 046 668, to which reference is expressly made especially in respect of the radicals R′, R″ and R′″ and the disclosure of which is regarded as being part of the disclosure of the present text. Especially suitable are, for example, acetyl acetone, butanoyl acetone, heptanoyl acetone, stearoyl acetone, palmitoyl acetone, lauroyl acetone, 7-tert-nonylthioheptanedione-2,4, benzoyl acetone, dibenzoylmethane, lauroylbenzoylmethane, palmitoylbenzoylmethane, stearoylbenzoylmethane, isooctylbenzoylmethane, 5-hydroxycapronylbenzoylmethane, tribenzoylmethane, bis(4-methylbenzoyl)methane, benzoyl-p-chlorobenzoylmethane, bis(2-hydroxybenzoyl)methane, 4-methoxybenzoylbenzoylmethane, bis(4-methoxybenzoyl)methane, benzoylformylmethane, benzoylacetylphenylmethane, 1-benzoyl-1-acetylnonane, stearoyl-4-methoxybenzoylmethane, bis(4-tert-butylbenzoyl)methane, benzoylphenylacetylmethane, bis(cyclohexanoyl)methane, dipivaloylmethane, 2-acetylcyclopentanone, 2-benzoylcyclopentanone, diacetoacetic acid methyl, ethyl, butyl, 2-ethylhexyl, dodecyl or octadecyl ester as well as propionyl or butyryl acetic acid esters having from 1 to 18 carbon atoms as well as stearoyl acetic acid ethyl, propyl, butyl, hexyl or octyl esters or polynuclear β-keto esters, as described in EP-A 433 230, to which reference is expressly made, or dehydracetic acid and also the zinc, magnesium or alkali salts thereof or the alkali, alkaline earth or zinc chelates of the mentioned compounds insofar as they exist.

1,3-Diketo compounds can be present in a stabilizer composition according to the invention in an amount of up to about 20% by weight, for example up to about 10% by weight.

Polyols are also suitable as additives in the context of the stabilizer composition according to the invention. Suitable polyols are, for example, pentaerythritol, dipentaerythritol, tripentaerythritol, bistrimethylolpropane, inositol, polyvinyl alcohol, bistrimethylolethane, trimethylolpropane, sorbitol, maltitol, isomaltitol, lactitol, lycasine, mannitol, lactose, leucrose, tris(hydroxymethyl) isocyanurate, palatinite, tetramethylolcyclohexanol, tetramethylolcyclopentanol, tetramethylolcycloheptanol, glycerol, diglycerol, polyglycerol, thiodiglycerol or 1-0-α-D-glycopyranosyl-D-mannitol dihydrate.

The polyols suitable as additives can be present in a stabilizer composition according to the invention in an amount of up to about 30% by weight, for example up to about 10% by weight.

Also suitable as additives are, for example, sterically hindered amines, such as those mentioned on pages 7 to 27 of EP-A 1 046 668. Reference is expressly made to the sterically hindered amines disclosed therein, the compounds mentioned therein being regarded as part of the disclosure of the present text.

The sterically hindered amines suitable as additives can be present in a stabilizer composition according to the invention in an amount of up to about 30% by weight, for example up to about 10% by weight.

For example, amino alcohols are also suitable as additives. Suitable amino alcohols in the context of the present invention are in principle any compounds having at least one OH group and a primary, secondary or tertiary amino group or a combination of two or more of the mentioned amino groups. In principle, in the context of the present invention both solid and liquid amino alcohols are suitable as a constituent of the stabilizer compositions according to the invention. In the context of the present invention, however, the content of liquid amino alcohols is, for example, so chosen that the entire stabilizer composition is substantially in solid form.

Amino alcohols suitable for use in the context of the present invention have, within the scope of a preferred embodiment of the present invention, a melting point higher than about 30° C., especially higher than about 50° C. Suitable amino alcohols are, for example, mono- or polyhydroxy compounds which are based on linear or branched, saturated or unsaturated aliphatic mono- or poly-amines.

There are suitable in this connection, for example, OH-group-carrying derivatives of primary mono- or poly-amino compounds having from 2 up to about 40, for example from 6 up to about 20, carbon atoms. Examples thereof are corresponding OH-group-carrying derivatives of ethylamine, n-propylamine, isopropylamine, sec-propylamine, tert-butylamine, 1-aminoisobutane, substituted amines having from 2 to about 20 carbon atoms, such as 2-(N,N-dimethylamino)-1-aminoethane. Suitable OH-group-carrying derivatives of diamines are, for example, those based on diamines having a molecular weight of from about 32 to about 200 g/mol, the corresponding diamines having at least two primary, two secondary, or one primary and one secondary amino group(s). Examples thereof are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines, such as diethylenetriamine or 1,8-diamino-4-aminomethyloctane, triethylamine, tributylamine, dimethylbenzylamine, N-ethyl-, N-methyl-, N-cyclohexyl-morpholine, dimethylcyclohexylamine, dimorpholinodiethyl ether, 1,4-diazabicyclo[2,2,2]octane, 1-azabicyclo[3,3,0]octane, N,N,N′,N′-tetramethylethylenediamine, N,N,N′,N′-tetramethylbutanediamine, N,N,N′,N′-tetramethyl-1,6-hexanediamine, pentamethyldiethylenetriamine, tetramethyldiaminoethyl ether, bis(dimethylaminopropyl)urea, N,N′-dimethylpiperazine, 1,2-dimethylimidazole and di(4-N,N-dimethylaminocyclohexyl)methane.

Especially suitable are aliphatic amino alcohols having from 2 to about 40, preferably from 6 to about 20, carbon atoms, for example 1-amino-3,3-dimethyl-pentane-5-ol, 2-aminohexane-2′,2″-diethanolamine, 1-amino-2,5-dimethylcyclohexane-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentane-methanol, 2-amino-2-ethyl-1,3-propanediol, 2-(dimethylaminoethoxy)-ethanol, aromatic-aliphatic or aromatic-cycloaliphatic amino alcohols having from 6 to about 20 carbon atoms, there coming into consideration as aromatic structures heterocyclic or isocyclic ring systems such as naphthalene or especially benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol as well as mixtures of two or more such compounds.

Within the scope of an especially preferred embodiment of the present invention, heterocyclic compounds having a cyclic ring system containing amino groups, whereas the OH groups being bonded to the ring either directly or preferably by way of spacers, are used as amino alcohols.

Within the scope of an especially preferred embodiment of the present invention there are used heterocyclic amino alcohols having at least 2, preferably at least 3, amino groups in the ring. As central ring component of the amino alcohols suitable for use according to the invention there are especially suitable the trimerisation products of isocyanates.

Special preference is thereby given to hydroxyl-group-containing isocyanurates of the general formula I

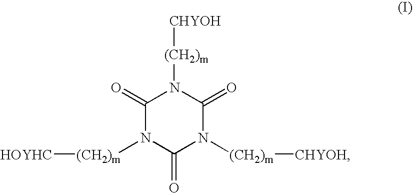

wherein the groups Y and the indices m are each identical or different and m is an integer from 0 to 20 and Y is a hydrogen atom or a linear or branched, saturated or unsaturated alkyl group having from 1 to about 10 carbon atoms. In the context of the present invention special preference is given to the use of tris(hydroxymethyl)isocyanurate (THEIC) as constituent of the stabilizer compositions according to the invention.

A stabilizer composition according to the invention can, for example, contain only one amino alcohol. In the context of the present invention, however, a stabilizer composition according to the invention can equally comprise a mixture of two or more different amino alcohols.

The content of a stabilizer composition according to the invention of such amino alcohols, in particular the content of THEIC is for example about 0.01 to about 10% by weight, as long as the stabilizer composition according to the invention contains such amino alcohols at all.

Also suitable as additives in the stabilizer compositions according to the invention are hydrotalcites, zeolites and alkali alumocarbonates. Suitable hydrotalcites, zeolites and alkali alumocarbonates are described, for example, on pages 27 to 29 of EP-A 1 046 668, on pages 3, 5 and 7 of EP-A 256 872, on pages 2 and 3 of DE-C 41 06 411 and on pages 2 and 3 of DE-C 41 06 404. Reference is expressly made to those specifications, and their disclosure at the indicated places is regarded as being part of the disclosure of the present text.

The hydrotalcites, zeolites and alkali alumocarbonates suitable as additives can be present in a stabilizer composition according to the invention in an amount of up to about 50% by weight, for example up to about 30% by weight.

Also suitable as additives in the context of the stabilizer compositions according to the invention are, for example, hydrocalumites of the general formula II

M²⁺₍₂₊ₓ₎Al³⁺_{(1+y)}(OH)_{(6+z)}A^{k-}ₐ[Bₙ]^{nl-}_{b}*mH₂O (II),

wherein M is calcium, magnesium or zinc or a mixture of two or more thereof, A is a k-valent inorganic or organic acid anion, k is 1, 2 or 3, B is an inorganic or organic acid anion other than A, n is a whole number≧1 and, when is n>1, indicates the degree of polymerisation of the acid anion, and l is 1, 2, 3 or 4 and indicates the valency of the acid anion, where, for n=1, l is 2, 3 or 4 and, for n>1,l indicates the valency of the individual monomer units of the polyanion and is 1, 2, 3 or 4 and nl indicates the total valency of the polyanion, and the following rules apply to the parameters x, y, a, b, n, z, and k:
0≦x<0.6,
0≦y<0.4, and where either x=0 or y=0,
0<a<0.8/n and
z=1+2x+3y−ka−n/b.

Within the scope of a preferred embodiment of the present invention, as additives there are used compounds of the general formula II wherein M is calcium, which may be in admixture with magnesium or zinc or magnesium and zinc.

In the general formula II, A is an k-valent inorganic or organic acid anion, wherein k is 1, 2 or 3. Examples of acid anions present in the context of hydrocalumites suitable for use according to the invention are halide ions, SO₃²⁻, SO₄²⁻, S₂O₃²⁻, S₂O₄²⁻, HPO₃²⁻, PO₄³⁻, CO₃²⁻, alkyl and dialkyl phosphates, alkyl mercaptides and alkyl sulfonates, wherein the alkyl groups may be identical or different, straight-chained, branched or cyclic and preferably have from 1 to about 20 carbon atoms. Also suitable as acid anions A are the anions of optionally functionalised di-, tri- or tetra-carboxylic acids, such as maleate, phthalate, aconitate, trimesate, pyro-mellitate, maleate, tartrate, citrate and also anions of the isomeric forms of hydroxyphthalic acid or hydroxymesic acid. Within the scope of a preferred embodiment of the present invention, A is an inorganic acid anion, especially a halide ion, for example F⁻, Cl⁻ or Br⁻, preferably Cl⁻.

In the general formula II, B is an acid anion other than A. For the case where n in the general formula II is the number 1, the letter B denotes a 1-valent inorganic or organic acid anion, wherein l is the number 2, 3 or 4. Examples of acid anions B present in the context of compounds of the general formula II suitable for use according to the invention are, for example, O²⁻, SO₃²⁻, SO₄²⁻, S₂O₃²⁻, S₂O₄²⁻, HPO₃²⁻, PO₄³⁻, CO₃²⁻, alkyl and dialkyl phosphates, alkyl mercaptides and alkyl sulfonates, wherein the alkyl groups may be identical or different, straight-chained or branched or cyclic and preferably have from 1 to about 20 carbon atoms. Also suitable as acid anions A are the anions of optionally functionalised di-, tri- or tetra-carboxylic acids, such as maleate, phthalate, aconitate, trimesate, pyromellitate, maleate, tartrate, citrate, and also anions of the isomeric forms of hydroxyphthalic acid or hydroxymesic acid. B in the context of the present invention in formula VII is preferably a borate or an anion of an optionally functionalised di-, tri- or tetra-carboxylic acid. Special preference is given to carboxylic acid anions and anions of hydroxycarboxylic acids having at least two carboxyl groups, very special preference being given to citrates.

For the case where n in the general formula II is a number greater than 1, the term [Bₙ]^{nl-} denotes an inorganic or organic polyanion having a degree of polymerisation n and the valency l of the individual monomer units of the polyanion with the total valency nl, wherein l is equal to or greater than 1. Examples of suitable polyanions [Bₙ]^{nl-} are polyacrylates, polycarboxylates, polyborates, polysilicates, polyphosphates and polyphosphonates.

In all the above-mentioned cases, the acid anions A and B can be present in any desired ratio a/b in the compounds of the general formula II.

The compounds of the general formula II are not compounds having a layered structure of the hydrotalcite or hydrocalumite type but a physical mixture of M²⁺/aluminium oxide hydrates with salts of divalent metals. X-ray diffractograms of the compounds of the general formula II used in the composition according to the invention clearly show that they are not discrete crystalline compounds of a known type but mixtures that are amorphous to X-rays.

For the preparation of the compounds according to the general formula II, solutions or suspensions of oxidic forms of the desired cations (e.g. NaAlO₂, Ca(OH)₂, Zn(OH)₂, Al(OH)₃) can, following known procedures, be mixed with solutions or suspensions of salts or the corresponding acids of the desired anions and reacted at temperatures of from 40 to 95° C., it being possible for the reaction times to be varied between 15 and 300 minutes.

When surface-treatment of the reaction products is desired, the surface-treatment medium can be added directly to the reaction products and the product can be separated from the mother liquor by filtration and dried at suitable temperatures between 100 and 250° C. The added amount of surface-treatment medium is, for example, from about 1 to about 20% by weight.

In the context of the stabilizer compositions according to the invention, compounds of the general formula II can be used in an amount of up to about 50% by weight, for example up to about 30% by weight or up to about 15% by weight.

Also suitable as additives to the stabilizer composition according to the invention are metal oxides, metal hydroxides and metal soaps of saturated, unsaturated, straight-chained or branched, aromatic, cycloaliphatic or aliphatic carboxylic acids or hydroxycarboxylic acids having especially from about 2 to about 22 carbon atoms.

As metal cations, the metal oxides, metal hydroxides or metal soaps suitable as additives have especially a divalent cation; the cations of calcium or zinc or mixtures thereof are especially suitable.

Examples of suitable carboxylic acid anions include anions of monovalent carboxylic acids, such as acetic acid, propionic acid, butyric acid, valeric acid, hexanoic acid, oenanthic acid, octanoic acid, neodecanoic acid, 2-ethylhexanoic acid, pelargonic acid, decanoic acid, undecanoic acid, dodecanoic acid, tridecanoic acid, myristic acid, palmitic acid, lauric acid, isostearic acid, stearic acid, 12-hydroxystearic acid, 9,10-dihydroxystearic acid, oleic acid, 3,6-dioxaheptanoic acid, 3,6,9-trioxadecanoic acid, behenic acid, benzoic acid, p-tert-butylbenzoic acid, dimethylhydroxybenzoic acid, 3,5-di-tert-butyl-4-hydroxybenzoic acid, toluic acid, dimethylbenzoic acid, ethylbenzoic acid, n-propylbenzoic acid, salicylic acid, p-tert-octylsalicylic acid, sorbic acid, anions of divalent carboxylic acids or monoesters thereof, such as oxalic acid, malonic acid, maleic acid, tartaric acid, cinnamic acid, mandelic acid, malic acid, glycolic acid, oxalic acid, salicylic acid, polyglycoldicarboxylic acids having a degree of polymerisation of from about 10 to about 12, phthalic acid, isophthalic acid, terephthalic acid or hydroxyphthalic acid, anions of tri- or tetra-valent carboxylic acids or mono-, di- or tri-esters thereof, as in hemimellitic acid, trimellitic acid, pyromellitic acid or citric acid, and also so-called overbased carboxylates as described, for example, in DE-A 41 06 404 or DE-A 40 02 988, the disclosure of the last-mentioned documents being regarded as part of the disclosure of the present text.

Within the scope of a preferred embodiment of the present invention, it is preferable to use metal soaps having anions derived from saturated or unsaturated carboxylic acids or hydroxycarboxylic acids having from about 8 to about 20 carbon atoms. Special preference is given to stearates, oleates, laurates, palmitates, behenates, versatates, hydroxystearates, dihydroxystearates, p-tert-butyl benzoates or (iso)octanoates of calcium or zinc or mixtures of two or more thereof. Within the scope of a further preferred embodiment of the present invention, a stabilizer composition according to the invention comprises calcium stearate or zinc stearate or a mixture thereof.

A stabilizer composition according to the invention can comprise the mentioned metal oxides, metal hydroxides or metal soaps, or a mixture of two or more thereof, in an amount of up to about 50% by weight, for example in an amount of up to about 30% by weight.

A stabilizer composition according to the invention can furthermore comprise as thermo stabilizer component an organotin compound or a mixture of two or more organotin compounds.

Furthermore, in the context of the stabilizer compositions according to the invention it is possible to use the organotin compounds which are mentioned and the preparation of which is described on pages 18 to 29 of EP-A 0 742 259. Reference is expressly made to the above-mentioned disclosure, the compounds mentioned therein and their preparation being understood as being part of the disclosure of the present text.

A stabilizer composition according to the invention can comprise the described organotin compounds in an amount of up to about 20% by weight, especially up to about 10% by weight.

Within the scope of a further embodiment of the present invention, a stabilizer composition according to the invention can comprise organic phosphite esters having from 1 to 3 organic radicals, which are identical, pairwise identical or different. Suitable organic radicals are, for example, linear or branched, saturated or unsaturated alkyl radicals having from 1 to 24 carbon atoms, unsubstituted or substituted alkyl radicals having from 6 to 20 carbon atoms or unsubstituted or substituted aralkyl radicals having from 7 to 20 carbon atoms. Examples of suitable organic phosphite esters are tris(nonylphenyl), trilauryl, tributyl, trioctyl, tridecyl, tridodecyl, triphenyl, octyldiphenyl, dioctylphenyl, tri(octylphenyl), tribenzyl, butyldicresyl, octyl-di(octylphenyl), tris(2-ethylhexyl), tritolyl, tris(2-cyclohexylphenyl), tri-α-naphthyl, tris(phenylphenyl), tris(2-phenylethyl), tris(dimethylphenyl), tricresyl or tris(p-nonylphenyl) phosphite or tristearyl sorbitol-triphosphite or mixtures of two or more thereof.

A stabilizer composition according to the invention can comprise the described phosphite compounds in an amount of up to about 30% by weight, especially up to about 10% by weight.

A stabilizer composition according to the invention can also comprise lubricants, such as montan wax, fatty acid esters, purified or hydrogenated natural or synthetic triglycerides or partial esters, polyethylene waxes, amide waxes, chloroparaffins, glycerol esters or alkaline earth soaps. Lubricants suitable for use are also described in “Kunststoffadditive”, R. Gächter/H. Müller, Carl Hanser Verlag, 3rd edition, 1989, pages 478-488. Also suitable as lubricants are, for example, fatty ketones, as described in DE 4,204,887, and also silicone-based lubricants, as mentioned, for example, in EP-A 0 259 783, or combinations thereof, as mentioned in EP-A 0 259 783. Reference is expressly made to the mentioned documents, the disclosure of which relating to lubricants is to be regarded as being part of the disclosure of the present text.

A stabilizer composition according to the invention can comprise the described lubricants in an amount of up to about 70% by weight, especially up to about 40% by weight.

Also suitable as additives for stabilizer compositions according to the present invention are organic plasticizers.

Suitable as plasticizers are, for example, compounds from the group of phthalic acid esters, such as dimethyl, diethyl, dibutyl, dihexyl, di-2-ethylhexyl, di-n-octyl, diisooctyl, diisononyl, diisodecyl, dicyclohexyl, dimethylcyclohexyl, dimethyl glycol, dibutyl glycol, benzylbutyl or diphenyl phthalate as well as mixtures of phthalates, for example mixtures of alkyl phthalates having from 7 to 9 or 9 to 11 carbon atoms in the ester alcohol or mixtures of alkyl phthalates having from 6 to 10 and 8 to 10 carbon atoms in the ester alcohol. Especially suitable in the sense of the present invention are dibutyl, dihexyl, di-2-ethylhexyl, di-n-octyl, diisooctyl, diisononyl, diisodecyl, diisotridecyl and benzylbutyl phthalate and also the mentioned mixtures of alkyl phthalates.

Also suitable as plasticizers are the esters of aliphatic dicarboxylic acids, especially the esters of adipic, azelaic or sebacic acid or mixtures of two or more thereof. Examples of such plasticizers are di-2-ethylhexyl adipate, diisooctyl adipate, diisononyl adipate, diisodecyl adipate, benzylbutyl adipate, benzyloctyl adipate, di-2-ethylhexyl azelate, di-2-ethylhexyl sebacate and diisodecyl sebacate. Within the scope of a further embodiment of the present invention preference is given to di-2-ethylhexyl acetate and diisooctyl adipate.

Also suitable as plasticizers are trimellitic acid esters, such as tri-2-ethylhexyl trimellitate, triisotridecyl trimellitate, triisooctyl trimellitate and also trimellitic acid esters having from 6 to 8, 6 to 10, 7 to 9 or 9 to 11 carbon atoms in the ester group or mixtures of two or more of the mentioned compounds.

Suitable plasticizers are also, for example, polymer plasticizers, as mentioned in “Kunststoffadditive”, R. Gächter/H. Müller, Carl Hanser Verlag, 3rd edition, 1989, chapter 5.9.6, pages 412-415, or “PVC Technology”, W. V. Titow, 4th Edition, Elsevier Publishers, 1984, pages 165-170. The starting materials most commonly used for the preparation of polyester plasticizers are, for example, dicarboxylic acids, such as adipic, phthalic, azelaic or sebacic acid, and diols, such as 1,2-propanediol, 1,3-butanediol, 1,4-butanediol, 1,6-hexanediol, neopentyl glycol or diethylene glycol or mixtures of two or more thereof.

Also suitable as plasticizers are phosphoric acid esters, such as those in “Taschenbuch der Kunststoffadditive”, chapter 5.9.5, pages 408-412. Examples of suitable phosphoric acid esters are tributyl phosphate, tri-2-ethylbutyl phosphate, tri-2-ethylhexyl phosphate, trichloroethyl phosphate, 2-ethyl-hexyl-di-phenyl phosphate, triphenyl phosphate, tricresyl phosphate or trixylenyl phosphate, or mixtures of two or more thereof.

Also suitable as plasticizers are chlorinated hydrocarbons (paraffins) or hydrocarbons as described in “Kunststoffadditive”, R. Gächter/H. Müller, Carl Hanser Verlag, 3rd edition, 1989, chapter 5.9.14.2, pages 422-425, and chapter 5.9.14.1, page 422.

A stabilizer composition according to the invention can comprise the described plasticizers in an amount of up to about 99.5% by weight, especially up to about 30% by weight, up to about 20% by weight or up to about 10% by weight. Within the scope of a preferred embodiment of the present invention, the lower limit for the described plasticizers as constituent of the stabilizer compositions according to the invention is about 0.1% by weight or more, for example about 0.5% by weight, 1% by weight, 2% by weight or 5% by weight.

Pigments are also suitable as constituents of the stabilizer compositions according to the invention. Examples of suitable inorganic pigments are titanium dioxide, carbon black, Fe₂O₃, Sb₂O₃, (Ba, Sb)O₂, Cr₂O₃, spinels, such as cobalt blue and cobalt green, Cd (S, Se) or ultramarine blue. Suitable organic pigments are, for example, azo pigments, phthalocyanine pigments, quinacridone pigments, perylene pigments, diketopyrrolopyrrole pigments or anthraquinone pigments.

A stabilizer composition according to the invention can also comprise fillers, such as those described on pages 393 to 449 of “Handbook of PVC Formulating”, E. J. Wickson, John Wiley & Sons, Inc., 1993, or reinforcing agents, such as those described on pages 549 to 615 of “Taschenbuch der Kunststoffadditive”, R. Gächter/H. Müller, Carl Hanser Verlag, 1990. Especially suitable fillers or reinforcing agents are, for example, calcium carbonate (chalk), dolomite, wollastonite, magnesium oxide, magnesium hydroxide, silicates, glass fibres, talc, kaolin, carbon black or graphite, wood flour or other renewable raw materials. Within the scope of a preferred embodiment of the present invention, a stabilizer composition according to the invention comprises chalk.

Within the scope of a further embodiment of the present invention, the stabilizer compositions according to the invention can comprise antioxidants, UV absorbers and light stabilizers or blowing agents. Suitable antioxidants are described, for example, on pages 33 to 35 of EP-A 1 046 668. Therein, suitable UV absorbers and light stabilizers are mentioned on the pages 35 and 36. Reference is expressly made to both disclosures, the disclosures being regarded as part of the present text.

Suitable blowing agents are, for example, organic azo and hydrazo compounds, tetrazoles, oxazines, isatoic anhydride, salts of citric acid, for example ammonium citrate, and also sodium carbonate and sodium hydrogen carbonate. Especially suitable are, for example, ammonium citrate, azodicarbonamide or sodium hydrogen carbonate or mixtures of two or more thereof.

A stabilizer composition according to the invention can also comprise impact strength modifiers and processing aids, gelling agents, antistatics, biocides, metal deactivators, optical brighteners, flame retardants and also antifogging compounds. Suitable compounds of those classes of compound are described, for example, in “Kunststoff Additive”, R. Keβler/H. Müller, Carl Hanser Verlag, 3rd edition, 1989 as well as in “Handbook of PVC Formulating”, E. J. Wilson, J. Wiley & Sons, 1993.

Within the scope of a preferred embodiment of the present invention, a stabilizer composition according to the invention can have a complex composition. In principle, the compounds already mentioned within the scope of this text are substantially applicable as constituent of the composition according to the invention. According to this, a stabilizer composition according to the invention can for example exclusively comprise compounds, which are effective in view of the initial colour or the colour stability. However, a stabilizer composition according to the invention can also comprise further above mentioned compounds, in particular additives, which effect the processability of halogen-containing plastics or the properties of moulded articles that are produced of such plastics.

The stabilizer compositions according to the invention are suitable for stabilizing halogen-containing polymers.

Examples of such halogen-containing polymers are polymers of vinyl chloride, vinyl resins containing vinyl chloride units in the polymer backbone, copolymers of vinyl chloride and vinyl esters of aliphatic acids, especially vinyl acetate, copolymers of vinyl chloride with esters of acrylic and methacrylic acid or acrylonitrile or mixtures of two or more thereof, copolymers of vinyl chloride with diene compounds or unsaturated dicarboxylic acids or anhydrides thereof, for example copolymers of vinyl chloride with diethyl maleate, diethyl fumarate or maleic anhydride, post-chlorinated polymers and copolymers of vinyl chloride, copolymers of vinyl chloride and vinylidene chloride with unsaturated aldehydes, ketones and other compounds such as acrolein, crotonaldehyde, vinyl methyl ketone, vinyl methyl ether, vinyl isobutyl ether and the like, polymers and copolymers of vinylidene chloride with vinyl chloride and other polymerisable compounds, such as those already mentioned above, polymers of vinyl chloroacetate and dichlorodivinyl ether, chlorinated polymers of vinyl acetate, chlorinated polymeric esters of acrylic acid and α-substituted acrylic acids, chlorinated polystyrenes, for example polydichlorostyrene, chlorinated polymers of ethylene, polymers and post-chlorinated polymers of chlorobutadiene and copolymers thereof with vinyl chloride and also mixtures of two or more of the mentioned polymers or polymer mixtures that contain one or more of the above-mentioned polymers.

Also suitable for stabilization with the stabilizer compositions according to the invention are the graft polymers of PVC with EVA, ABS or MBS. Preferred substrates for such graft copolymers are also the afore-mentioned homo- and co-polymers, especially mixtures of vinyl chloride homopolymers with other thermoplastic or elastomeric polymers, especially blends with ABS, MBS, NBR, SAN, EVA, CPE; MBAS, PAA (polyalkyl acrylate), PAMA (polyalkyl methacrylate), EPDM, polyamides or polylactones.

Likewise suitable for stabilization with the stabilizer compositions according to the invention are mixtures of halogenated and non-halogenated polymers, for example mixtures of the above-mentioned non-halogenated polymers with PVC, especially mixtures of polyurethanes and PVC.

Furthermore, it is also possible for recyclates of chlorine-containing polymers to be stabilized with the stabilizer compositions according to the invention, in principle any recyclates of the above-mentioned halogenated polymers being suitable for this purpose. PVC recyclate is for example suitable in the context of the present invention.

The preparation of a stabilizer composition according to the invention can substantially be carried out by any way. The constituents of a stabilizer composition according to the invention are preferably mixed in an order that allows on the one hand a most economical procedure and on the other hand brings forth stabilizer compositions having as good as possible stabilizing properties. Therefore, a subject matter of the present invention is also a process for the production of a stabilizer composition according to the invention, in which at least one lead compound and at least one salt of a halogen-containing oxy acid is mixed.

Therefore, a further subject matter of the present invention relates to a polymer composition at least comprising a halogenated polymer and a stabilizer composition according to the invention.

Within the scope of a preferred embodiment of the present invention, a polymer composition according to the invention comprises the stabilizer composition according to the invention in an amount of from 0.1 to 40 phr, especially from about 0.5 to about 30 phr or from about 1 to about 20 phr. The unit phr represents “per hundred resin” and thus relates to parts by weight per 100 parts by weight of polymer. A polymer composition according to the invention preferably comprises at least in part PVC as halogenated polymer, whereas the proportion of PVC is in particular at least about 20, preferably at least about 50% by weight, for example at least about 80 or at least about 90% by weight.

The present invention relates to a process for stabilizing halogen-containing polymers, in which a halogen-containing polymer or a mixture of one or more halogen-containing polymers and one or more halogen-free polymers is mixed with a stabilizer composition according to the invention.

The mixing together of polymer or polymers and the stabilizer composition according to the invention can in principle be effected at any time before or during the processing of the polymer. Thus, for example, the stabilizer composition can be mixed into the polymer prior to the processing, which is in powder or granule form. It is equally possible, however, to add the stabilizer composition to the polymer or polymers in the softened or molten state, for example during the processing in an extruder, as emulsion or as dispersion, as pasty mixture, as dry mixture, as solution or melt.

A polymer composition according to the invention can be brought into a desired form in a known manner. Suitable methods are, for example, calendering, extrusion, injection-moulding, sintering, extrusion blowing or the plastisol process. A polymer composition according to the invention can also be used, for example, in the production of foamed materials. In principle, the polymer compositions according to the invention are suitable for the production of hard or soft PVC.

A polymer composition according to the invention can be processed to form moulded articles. The present invention therefore also relates to moulded articles, at least comprising a stabilizer composition according to the invention or a polymer composition according to the invention.

The term “moulded article” in the context of the present invention includes in principle any three-dimensional structures that can be produced from a polymer composition according to the invention. In the context of the present invention the term “moulded article” includes, for example, wire sheathings, automobile components, for example automobile components such as are used in the interior of the automobile, in the engine space or on the outer surfaces, cable insulators, decorative films, agricultural films, hoses, shaped sealing elements, office films, hollow bodies (bottles), packaging films, (deep-draw films), blown films, tubes, foamed materials, heavy duty profiles (window frames), light wall profiles, structural profiles, sidings, fittings, plates, foamed panels, co-extrudates having a recycled core, or housings for electrical apparatus or machinery, for example computers or household appliances.

Further examples of moulded articles that can be produced from a polymer composition according to the invention are synthetic leather, floor coverings, textile coatings, wallcoverings, coil coatings and underseals for motor vehicles.

The use of a mixture comprising at least one lead compound or a mixture of two or more lead compounds and at least a salt of a halogen-containing oxy acid, whereas at least one salt of a halogen-containing oxy acid is present in supported form, for the stabilization of halogen-containing polymers, is also a subject matter of the invention. Within the scope of a preferred embodiment of the present invention, thereby the mixture comprises at least 20% by weight of a lead compound or a mixture of two or more lead compounds or a salt of a halogen-containing oxy acid or a mixture of two or more salts of one or more halogen-containing oxy acids or both. The invention is illustrated in more detail by the following examples.

### EXAMPLES

The following formulations indicated as examples 1 to 10 have been prepared for screening the stabilizer compositions according to the invention. The composition of the formulations is given in the following tables:

| Raw material | 1 | 2 | 3 | 4 | 5 | 6 | 7 | 8 | 9 | 10 |
|---|---|---|---|---|---|---|---|---|---|---|
| PVC (Vestolit P 1982K) | 100 | 100 | 100 | 100 | 100 | 100 | 100 | 100 | 100 | 100 |
| Titanium dioxide | 4.00 | 4.00 | 4.00 | 4.00 | 4.00 | 4.00 | 4.00 | 4.00 | 4.00 | 4.00 |
| Chalk | 6.00 | 6.00 | 6.00 | 6.00 | 6.00 | 6.00 | 6.00 | 6.00 | 6.00 | 6.00 |
| Dibasic lead phosphite | 3.5 | 3.5 | 3.5 | 3.5 | 3.5 | 3.5 | 3.5 | 3.5 | 3.5 | 3.5 |
| Dibasic lead stearate | 0.6 | 0.6 | 0.6 | 0.6 | 0.6 | 0.6 | 0.6 | 0.6 | 0.6 | 0.6 |
| Neutral lead stearate | 0.46 | 0.46 | 0.46 | 0.46 | 0.46 | 0.46 | 0.46 | 0.46 | 0.46 | 0.46 |
| Calcium stearate | 0.35 | 0.35 | 0.35 | 0.35 | 0.35 | 0.35 | 0.35 | 0.35 | 0.35 | 0.35 |
| Distearylphthalate | 0.71 | 0.71 | 0.71 | 0.71 | 0.71 | 0.71 | 0.71 | 0.71 | 0.71 | 0.71 |
| Polyacrylate (flowing aid) | 0.9 | 0.9 | 0.9 | 0.9 | 0.9 | 0.9 | 0.9 | 0.9 | 0.9 | 0.9 |
| THEIC | 0.1 | 0.1 | 0.1 | 0.1 | 0.1 | 0.1 | 0.1 | 0.1 | 0.1 | 0.1 |
| Sodium perchlorate on an | | 0.1 | 0.05 | 0.01 | | | | | | |
| inert support | | | | | | | | | | |
| Sodium perchlorate on the | | | | | 0.1 | 0.05 | 0.01 | | | |
| supporting material | | | | | | | | | | |
| Ca(OH)₂ | | | | | | | | | | |
| Sodium perchlorate on the | | | | | | | | 0.1 | 0.05 | 0.01 |
| supporting material CaA- | | | | | | | | | | |
| lOH-Phosphite | | | | | | | | | | |

The formulations obtained that way were each subjected to a test according to DIN VDE 0472 part 614 (HCl test). Thereby, a metal block thermostat of the company Liebisch was applied as testing device. Per sample, three sample units of a weight of 50±5 mg were applied as sample. The testing temperature was 200±0.5° C. The single values as well as the mean value of the stability times of the three sample units were determined as evaluation. In this context the following values were obtained.

| Sample | Stability time 1 | Stability time 2 | Stability time 3 | Mean value |
|---|---|---|---|---|
| No | [min] | [min] | [min] | [min] |
| 1 | 66 | 68 | 68 | 67 |
| 2 | 79 | 80 | 82 | 80 |
| 3 | 80 | 82 | 83 | 82 |
| 4 | 77 | 78 | 78 | 78 |
| 5 | 82 | 83 | 83 | 83 |
| 6 | 84 | 84 | 85 | 84 |
| 7 | 80 | 81 | 81 | 81 |
| 8 | 83 | 84 | 85 | 84 |
| 9 | 80 | 81 | 81 | 81 |
| 10 | 74 | 75 | 76 | 75 |

Furthermore, the formulations according to examples 1 to 10 were subjected to a DHC test according to UEAtc (Union Européenne pour l'Agrément techique dans la construction, 1978, Secretariat General: 4, Avenue du Recteur Poincé 75782 Paris Cedex 16).

Thereby, the following stability values were obtained:

| Sample identifier | DHC according to UEAtc |
|---|---|
| 1 | 106 min |
| 2 | 212 min |
| 3 | 187 min |
| 4 | 150 min |
| 5 | 215 min |
| 6 | 195 min |
| 7 | 150 min |
| 8 | 201 min |
| 9 | 184 min |
| 10 | 124 min |

The results clearly show that already a minor proportion of perchlorates, in particular of perchlorates as they are applied within the scope of the present examples, exhibit a significant enhancement of the thermo stability in the particularly sensitive UEAtc test.

The testing methods for the determination of the thermo stability DHC according to DIN and DHC according to UEAtc, which are relevant for the practical experience and which are verified for quality assurance of important objects of utility, show depending on the method of measurement a significant enhancement of the stability times on a different level.

1-10. (canceled)

11. A stabilizer composition for one or more halogen-containing polymers, at least comprising:
a lead compound or a mixture of two or more lead compounds; and
a salt of a halogen-containing oxy acid or a mixture of two or more salts of one or more halogen-containing oxy acids,
whereas the stabilizer composition comprises at least one salt of a halogen-containing oxy acid in supported form.

12. The stabilizer composition according to claim 11, wherein said one lead compound or said mixture of two or more lead compounds is present in an amount of at least 5% by weight.

13. The stabilizer composition according to claim 12, wherein said halogen-containing oxy acid or said mixture of two or more salts of one or more halogen-containing oxy acids us present in an amount of 0.005 to 0.5% by weight.

14. The stabilizer composition according to claim 13, wherein at least one salt of a halogen-containing oxy acid is present in a form, in which, based on the total content of the salt of a halogen-containing oxy acid, less than 10% of the crystallites of the salt of a halogen-containing oxy acid have a crystallite size of more than 3 μm.

15. The stabilizer composition according to claim 12, wherein at least one salt of a halogen-containing oxy acid is present in a form, in which, based on the total content of the salt of a halogen-containing oxy acid, less than 10% of the crystallites of the salt of a halogen-containing oxy acid have a crystallite size of more than 3 μm.

16. The stabilizer composition according to claim 11, wherein said halogen-containing oxy acid or said mixture of two or more salts of one or more halogen-containing oxy acids us present in an amount of 0.005 to 0.5% by weight.

17. The stabilizer composition according to claim 16, wherein at least one salt of a halogen-containing oxy acid is present in a form, in which, based on the total content of the salt of a halogen-containing oxy acid, less than 10% of the crystallites of the salt of a halogen-containing oxy acid have a crystallite size of more than 3 μm.

18. The stabilizer composition according to claim 11, wherein at least one salt of a halogen-containing oxy acid is present in a form, in which, based on the total content of the salt of a halogen-containing oxy acid, less than 10% of the crystallites of the salt of a halogen-containing oxy acid have a crystallite size of more than 3 μm.

19. The stabilizer composition according to claim 11, wherein the lead compound or a mixture of two or more lead compounds is present in an amount of at least 20% by weight.

20. The stabilizer composition according to claim 19, wherein said halogen-containing oxy acid or said mixture of two or more salts of one or more halogen-containing oxy acids us present in an amount of 0.005 to 0.5% by weight.

21. The stabilizer composition according to claim 19, wherein at least one salt of a halogen-containing oxy acid is present in a form, in which, based on the total content of the salt of a halogen-containing oxy acid, less than 10% of the crystallites of the salt of a halogen-containing oxy acid have a crystallite size of more than 3 μm.

22. The stabilizer composition according to claim 11, wherein the salt of a halogen-containing oxy acid or the mixture of two or more salts of one or more halogen-containing oxy acids is present in an amount of at least 20% by weight.

23. The stabilizer composition according to claim 11, further comprising one or more additives.

24. A process for producing a stabilizer composition, comprising mixing a lead compound or a mixture of two or more lead compounds and a salt of a halogen-containing oxy acid or a mixture of two or more salts of one or more halogen-containing oxy acids, wherein the stabilizer composition comprises at least one salt of a halogen-containing oxy acid in supported form.

25. A polymer composition, at least comprising:
a halogenated polymer; and
a stabilizer composition comprising a lead compound or a mixture of two or more lead compounds and a salt of a halogen-containing oxy acid or a mixture of two or more salts of one or more halogen-containing oxy acids, wherein the stabilizer composition comprises at least one salt of a halogen-containing oxy acid in supported form.

26. The polymer composition according to claim 25, wherein said one lead compound or said mixture of two or more lead compounds is present in an amount of at least 5% by weight.

27. The polymer composition according to claim 25, wherein said halogen-containing oxy acid or said mixture of two or more salts of one or more halogen-containing oxy acids us present in an amount of 0.005 to 0.5% by weight.

28. The polymer composition according to claim 25, wherein at least one salt of a halogen-containing oxy acid is present in a form, in which, based on the total content of the salt of a halogen-containing oxy acid, less than 10% of the crystallites of the salt of a halogen-containing oxy acid have a crystallite size of more than 3 μm.

29. The polymer composition according to claim 25, wherein the lead compound or a mixture of two or more lead compounds is present in an amount of at least 20% by weight.

30. A process for stabilizing one or more halogen-containing polymers, comprising mixing
(a) a stabilizer composition comprising a lead compound or a mixture of two or more lead compounds and a salt of a halogen-containing oxy acid or a mixture of two or more salts of one or more halogen-containing oxy acids, wherein the stabilizer composition comprises at least one salt of a halogen-containing oxy acid in supported form with
(b) a halogen-containing polymer, a mixture of two or more halogen-containing polymers, or a mixture of one or more halogen-containing polymers and one or more halogen-free polymers.
